(19) United States
(12) Patent Application Publication
(10) Pub. No.: US 2005/0007234 A1
(43) Pub. Date: Jan. 13, 2005

(54) Fusible alloy and thermal fuse

(76) Inventors: Tatsuya Wada, Miyazaki (JP); Shinichi Otsuka, Miyazaki (JP); Takahiro Mukai, Miyazaki (JP); Masatoshi Izaki, Miyazaki (JP)

Correspondence Address: WENDEROTH, LIND & PONACK, L.L.P., 2033 K STREET N. W., SUITE 800, WASHINGTON, DC, 20006-1021, US

(21) Appl. No.: 10/872,563

(22) Filed: Jun. 22, 2004

(30) Foreign Application Priority Data
Jul. 11, 2003 (JP) 2003-195587
Oct. 27, 2003 (JP) 2003-365667

(51) Int. Cl. H01H 85/06

(52) U.S. Cl. 337/405

(57) ABSTRACT

The thermal fuse of the present invention contains a fuse element 1 that is formed of a fusible alloy having a composition of 43.5-50 wt % Sn, 0.1-5 wt % In, and balance being Bi and inevitable impurities, or a fusible alloy having a composition of 5-33 wt % In, 4.7-15.5 wt % Zn, and balance being Sn and inevitable impurities; a pair of electric terminals 2, 3 connected to the fuse element; and case 8 for accommodating at least the fuse element 1. The opening end of case 8 has a predetermined shape. By employing the structure above, a thermal fuse having an operating temperature as high as 130-190° C. can be easily obtained.

### TECHNICAL FIELD

The present invention relates to a fusible alloy for a fuse, and a thermal fuse formed of the fusible alloy preferably employed for protecting electronic devices from damage caused by abnormal overheat, over current, and the like.

### BACKGROUND OF THE INVENTION

Electronic devices and batteries for mobile phones could suffer damage from overheating and the like. To take precautions against such possible damage due to abnormal overheat and other causes, a thermal fuse should preferably be fixed to them. For example, when a battery has a short circuit between the positive and the negative terminals by some reason, an abrupt discharge occurs, by which the battery generates excessive heat. Because of the heat generation, the battery itself or electronic components disposed close to the battery could cause breakdowns or operate improperly. In a battery charger and an adaptor, generated heat can increase the temperature of the device; a thermal fuse should preferably be fixed in such components.

A thermal fuse contains a fuse element made of a fusible alloy, which melts at a certain temperature, and terminal sections disposed at both ends of the fuse element. Each terminal section is connected to a part of a circuit. When abnormal overheat occurs in the circuit, the fuse element melts by the raised temperature, whereby electrical connections are broken down. This protects the battery and other components from damage.

The temperature at which a thermal fuse burns depends on the fusing temperature of the fusible alloy forming the fuse element. The operating temperature of a thermal fuse is determined by controlling the fusing temperature of the fusible alloy used for the fuse. Conventionally popular fuses were the ones that operated at around 100° C. Whereas recently, as the need for a safeguard against overheat grows, the demand for a thermal fuse suitable for battery chargers and adaptors has been increasing. That is, a fusible alloy having a fusing temperature in the range of 130-190° C. and a thermal fuse employing the fusible alloy have been desired.

Besides, the fusible alloy forming a conventional fuse element often included an environmental burden substance, such as lead (Pb). To address the problem, Japanese Patent Non-Examined Publication No. 2003-82430 discloses a Pb-free fusible alloy, i.e., a binary or ternary fusible alloy formed of indium (In), tin (Sn), and bismuth (Bi).

FIG. 21 is a sectional view illustrating the structure of a prior-art axial-type thermal fuse. FIG. 22 is a perspective view illustrating the structure of a prior-art radial-type thermal fuse.

Each of axial-type thermal fuse 100 and radial-type thermal fuse 106 contains case 101, fuse element 102, flux 103, electric terminals 104, and sealer 105.

In axial-type thermal fuse 100, case 101 accommodates fuse element 102 formed of fusible alloy. Electric terminals 104 including lead terminals are connected to both ends of fuse element 102. Sealer 105 including resin seals the ends of case 101, preventing spillover of the melted fusible alloy to the outside of case 101 when the fuse element melts. Flux 103 covers fuse element 102 to enhance fusing characteristics.

In radial-type thermal fuse 106, like axial-type thermal fuse 100, fuse element 102 and flux 103 are accommodated in case 101. Electric terminals 104 are connected to fuse element 102, and sealer 105 seals openings disposed for easily accommodating the fuse element and the flux in the case.

However, a Pb-free alloy, i.e., a binary or ternary fusible alloy formed of indium (In), tin (Sn), and bismuth (Bi) with the prior-art composition ratio has a low fusing temperature. With such an alloy, a thermal fuse for lighting equipment, in which an operating temperature in the range of 130° C. to 190° C. is required, has not been constructed.

In addition, a prior-art thermal fuse is so designed that the fuse element is housed in a case formed into a rectangular parallelepiped, a cube, or a right circular cylinder. With such structures, a problem occurs in sealing the opening of the case—too much process time required for sealing degrades durability, so that the elements have exhibited a wide range of variations in quality. In particular, since the end walls of the case adjacent to the openings rise straight up, the sealing process requires extra steps, for example, injecting the sealer into the inside of the case and covering the openings with a large amount of the sealer, thereby consuming the manufacturing time. Besides, spillover of the sealer to outside the case has frequently occurred. If the sealer having a high coefficient of thermal expansion spills out the case and adheres to the case and electric terminals, an undesired stress is applied to the terminal when the temperature rises, whereby the intended behavior of the fuse at the operating temperature is interrupted. The fusible alloy itself may melt at a high temperature even in such unintended state, however, the thermal fuse may be unable to work in the target temperature-range of 130-190° C.

### SUMMARY OF THE INVENTION

The thermal fuse of the present invention contains a fuse element made of fusible alloy, a pair of electric terminals connected to the fuse element, and a case accommodating at least the fuse element. The case is shaped into a structure having confronting ends in not parallel relation. With the structure above, the thermal fuse melts at a temperature in the range of 130° C. to 190° C. In addition, the thermal fuse has no spillover of a sealer made of resin or the like to outside the case.

The fusible alloy of the present invention has a composition of 43.5-50 wt % Sn; 0.1-5 wt % In; the balance being Bi and inevitable impurities. The fusible alloy with the composition above has a fusing temperature in the range of 128° C. to 138° C. The fusible alloy is optimal for a thermal fuse that operates at around 133° C.

The fuse element of the present invention is made of a fusible alloy with a composition of 43.5-50 wt % Sn; 0.1-5 wt % In; the balance being Bi and inevitable impurities. The fusible alloy with the composition above has a fusing temperature in the range of 128° C. to 138° C. With the fusible alloy, the fuse element is formed into a plate-like, rod-like, or wire-like structure.

Another fusible alloy of the present invention has a composition of 5-33 wt % In; 4.7-15.5 wt % zinc (Zn); the balance being Sn and inevitable impurities. With the composition above, the fusible alloy has a fusing temperature in the range of 160° C. to 190° C.

A thermal fuse of the present invention has a transparent or translucent cover and colored flux disposed inside the cover, so that the proper separation of the melted fuse element is enhanced.

A method of manufacturing the fusible alloy of the present invention has the steps of measuring 5-33 wt % In, 4.7-15.5 wt % Zn, and the balance being Sn; mixing and melting the alloys above in a fusing furnace; and cooling the melted mixture. Through the steps, a fusible alloy having a fusing temperature in the range of 160° C. to 190° C. can be obtained.

### BRIEF DESCRIPTION OF THE DRAWINGS

FIG. 1 is a ternary composition diagram of the fusible alloy of a first embodiment of the present invention.

FIG. 2 is a perspective view of the fuse section of a second embodiment of the present invention.

FIG. 3 is another perspective view of the fuse section of the second embodiment.

FIG. 4 is a sectional view of the fuse section of the second embodiment.

FIG. 5 is another perspective view of the fuse section of the second embodiment.

FIG. 6 is a perspective view of the case of the second embodiment.

FIG. 7 is a perspective view of the thermal fuse of the second embodiment.

FIG. 8 illustrates the sealing process on the openings of the case of the second embodiment.

FIG. 9 is a perspective view of the thermal fuse, with both ends of the case sealed, of the second embodiment.

FIG. 10 is a sectional view of the thermal fuse of the second embodiment.

FIG. 11 is a perspective view of the case of the second embodiment.

FIG. 12 is a perspective view of another case of the second embodiment.

FIG. 13 is a perspective view of a radial type thermal fuse of the second embodiment.

FIG. 14 is a perspective view of the case of the radial type thermal fuse of the second embodiment.

FIG. 15 is a ternary composition diagram of the fusible alloy of a third embodiment.

FIG. 16 illustrates the manufacturing process of the fuse element of a fourth embodiment.

FIG. 17 is a perspective view of an axial type thermal fuse of a fifth embodiment.

FIG. 18 is a perspective view of a radial type thermal fuse of the fifth embodiment.

FIG. 19 is a perspective view of a slim type thermal fuse of the fifth embodiment.

FIG. 20 is a perspective view of an assembled cell of the fifth embodiment.

FIG. 21 is a sectional view of a conventional axial type thermal fuse.

FIG. 22 is a perspective view of a conventional radial type thermal fuse.

### DESCRIPTION OF THE INVENTION

A thermal fuse of the present invention contains a fuse element made of fusible alloy; two electric terminals connected to the fuse element; a case accommodating the fuse element. The case is so designed that at least one opening end is beveled at an angle with respect to a virtual plane that is vertical to a protruding direction of the electric terminal. The structure that satisfies the condition above includes the edge portion obtained by cutting a cylindrical or a rectangular parallelepiped case at a bevel, and a stepped edge portion.

Another thermal fuse of the present invention contains a fuse element made of fusible alloy; a pair of electric terminals connected to the fuse element; and a case accommodating at least the fuse element. The case contains non-parallel opposing ends. With the structure above, the thermal fuse has an operating temperature of 130-190° C., and has no spillover of a sealer including resin to outside the case.

Still another thermal fuse of the present invention has a case in which both ends disposed in non-parallel with each other of the case are the opposing ends through which the electric terminals protrude. Such a structure not only enhances the efficiency of the sealing process on the openings of the case, but also reducing spillover of a sealer to the outside of the case.

Yet another thermal fuse of the present invention has the case in which at least a part of the non-parallel opposing ends contains a notch, so that the spillover of a sealer outside the case can be reduced.

Another thermal fuse of the present invention has a case in which at least one end of the opposing ends disposed in non-parallel with each other is not vertical to the protruding direction of the electric terminals. By virtue of the structure, sealer can be applied to the openings of the case, with a sealer dispenser held vertical to the lengthwise direction of the case, whereby the sealing process is efficiently performed with a smaller amount of the sealer.

Still another thermal fuse of the present invention has a structure in which a section taken along the protruding direction of the electric terminals is substantially shaped into a trapezoid. By virtue of the structure, sealer can be applied to the openings of the case with a sealer dispenser held vertical to the lengthwise direction of the case, whereby the sealing process is efficiently performed with a smaller amount of the sealer.

Yet another thermal fuse of the present invention has a case in which the sides along the protruding direction of the electric terminals have the maximum length and the minimum length of the sides of the case. Cutting the openings at a bevel enhances the efficiency of the sealing process and prevents the spillover of the sealer to the outside of the case.

Still another thermal fuse of the present invention is an axial-type thermal fuse in which a pair of electric terminals protrudes from confronting both ends of the case. The axial-type thermal fuse operates at a temperature in the range of 130° C. to 190° C. with high durability.

Yet another thermal fuse of the present invention is a radial-type thermal fuse in which a pair of electric terminals protrudes from any given end of the case. The radial-type thermal fuse has an operating temperature in the range of 130° C. to 190° C. with high durability.

Another thermal fuse of the present invention has a structure in which flux is sealed in the case so as to contact with the fuse element. The structure provides the effect of facilitating proper separation of the melted fuse element.

Still another thermal fuse of the present invention has a transparent or translucent case and colored flux disposed inside the case. With the structure, discrimination between defective or good can be automatically evaluated by image recognition.

Yet another thermal fuse of the present invention is made of a first fusible alloy having a composition of 43.5-50 wt % Sn; 0.1-5 wt % In; the balance being Bi and inevitable impurities. The fusible alloy with the composition above can be formed into a thermal fuse that properly operates at around 133° C.

Another thermal fuse of the present invention contains a fuse element made of a second fusible alloy having a composition of 5-33 wt % In, 4.7-15.5 wt % Zn, and the balance being Sn and inevitable impurities; two electric terminals connected to both ends of the fuse element; and a cover for accommodating at least the fuse element. With the structure above, a thermal fuse that operates at a temperature in the range of 160° C. to 190° C. can be obtained.

Still another thermal fuse of the present invention is a radial-type thermal fuse having a structure in which two electric terminals protrude in the same direction from the same end of the cover. The thermal fuse has a fuse element made of the second fusible alloy, operating at a temperature in the range of 160° C. to 190° C. The thermal fuse can be fixed with flexibility according to a layout of components.

Yet another thermal fuse of the present invention is an axial-type thermal fuse having a structure in which each of two electric terminals protrudes from confronting each end of the case. The thermal fuse has a fuse element made of the second fusible alloy, operating at a temperature in the range of 160° C. to 190° C. The thermal fuse can be fixed with flexibility according to a layout of components.

Another thermal fuse of the present invention contains a substrate; a pair of lead terminals disposed on the substrate; a fuse element disposed across the pair of lead terminals; and a cover accommodating at least the fuse element. The thermal fuse has a fuse element made of the second fusible alloy, operating at a temperature in the range of 160° C. to 190° C.

A fuse element of the. present invention has a plate-like, rod-like, or wire-like structure, which is made of the first fusible alloy or the second fusible alloy. With the structure, an optimal fuse element having a fusing temperature in the range of 130° C. to 190° C. can be obtained.

A first fusible alloy of the present invention has a composition of 43.5-50 wt % Sn; 0.1-5 wt % In; the balance being Bi and inevitable impurities. The fusible alloy with the composition above has a fusing temperature in the range of 128° C. to 138° C., so that the fusible alloy is optimal for a thermal fuse that operates at around 133° C.

A second fusible alloy of the present invention has a composition of 5-33 wt % In; 4.7-15.5 wt % Zn; the balance being Sn and inevitable impurities. The fusible alloy with the composition above has a fusing temperature in the range of 160° C. to 190° C.

Preferably, the second fusible alloy of the present invention should contain 9-15 wt % In. The fusible alloy with the composition above has a fusing temperature in the range of 160° C. to 190° C. and exhibits a smaller range of variations in fusing temperatures.

Further preferably, the second fusible alloy of the present invention should contain 51.5-90.3 wt % Sn. The fusible alloy with the composition above has a fusing temperature in the range of 160° C. to 190° C. A method of manufacturing the second fusible alloy has the steps of measuring 5-33 wt % In, 4.7-15.5 wt % Zn, and the balance being Sn; melting a mixture of the elements above in a fusing furnace to obtain an alloy; and cooling the melted alloy. Through the steps, a fusible alloy having a fusing temperature in the range of 160° C. to 190° C. can be obtained.

The exemplary embodiments of the present invention are described in detail hereinafter with reference to the accompanying drawings.

First Exemplary Embodiment

First will be described the relationship between a fusing temperature and liquidus/solidus temperatures of fusible alloy. When fusible alloy melts by heating, the alloy generally experiences changes in the order of the solid phase, the solid-liquid coexisting phase and then the liquid phase. In the process, the boundary temperature between the solid phase and the solid-liquid coexisting phase is described as a solidus temperature; similarly, the boundary between the solid-liquid coexisting phase and the liquid phase is described as a liquidus temperature. A fusible alloy has a fusing temperature at somewhere (fairly closer to the liquidus temperature) between the solidus temperature and the liquidus temperature. The larger the difference between a solidus temperature and a liquidus temperature in a fusible alloy is, more increase variations in fusing temperatures are. On the other hand, the smaller the difference between the two temperatures above, more decrease variations in fusing temperatures are, thereby enhancing reliability and an operating life of the component made of the alloy.

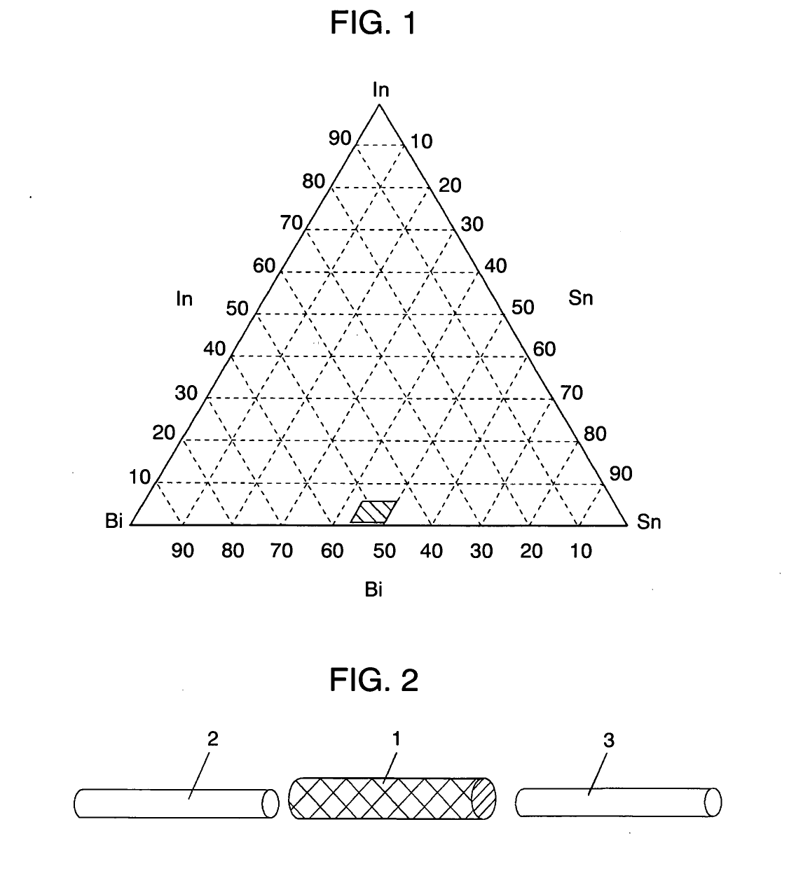

FIG. 1 is a ternary composition diagram of the fusible alloy of the first embodiment of the present invention. FIG. 1 shows compositional relationship of indium (In), tin (Sn) and bismuth (Bi). Each side of the triangle of FIG. 1 bears percent by weight of each element. The scale on the base of the triangle is for the percent by weight of Bi; the scales on the right and left sides are for Sn and In, respectively. In the triangle, each value of wt % is connected by broken lines. The diagonally shaded area indicated by solid lines is the area that satisfies the composition ratio of the first fusible alloy of the present invention.

The first fusible alloy of the present invention is a ternary alloy formed of indium (In), tin (Sn) and bismuth (Bi), except for inevitable impurities. The reason why the three elements of In, Sn and Bi are used will be described hereinafter.

The advantage of using indium (In) is in effectively decreasing a melting point of a fusible alloy. Usually, a single metal has a considerably high melting point; it is not suitable for the purpose of a thermal fuse which melts at a predetermined temperature and cuts off electrical connections. The melting point of a fusible alloy is required to be below a certain temperature. By virtue of the aforementioned advantage, i.e., being effective in decreasing the melting point of a fusible alloy, In is an optimal metallic element for forming a fusible alloy. Therefore, increasing the percentage of In of a fusible alloy can decrease the fusing temperature of the alloy, on the other hand, decreasing the percentage of In can increase the fusing temperature.

Tin (Sn) is easy to mix with zinc (Zn) and In, contributing to a consistently formed alloy. As another effect, adding Sn increases wettability of the fusible alloy. A fusible alloy with high wettability is suitable not only for coating, but also for rolling. Sn is thus preferable element to form alloy. As an additional advantage, Sn is an inexpensive metal and useful for low cost production of fusible alloy. Considering above, Sn is an optimal major constituent of fusible alloy.

As for bismuth (Bi), as is the case with In, the element has an effect of lowering a melting point of a fusible alloy. Adding Bi can control the fusing temperature of the alloy to a desired level, i.e., around 133° C.

Next will be described the reason why the composition ratio of the first fusible alloy of the present invention is determined to the following ranges: 0.1-5 wt % In; 43.5-50 wt % Sn; and the balance being Bi and inevitable impurities.

First, the reason for mixing 0.1-5 wt % In is described. The fusible alloy without In is ineffective in decreasing the melting point of the alloy. Therefore, the target temperature at around 133° C. cannot be obtained. On the other hand, the fusible alloy containing more than 5 wt % In exhibits too large difference between the liquidus and solidus temperatures, thereby giving two or more peaks in fusing temperatures or inconsistent fusing of the alloy.

Next will be described the reason for mixing 43.5-50 wt % Sn. The fusible alloy containing less than 43.5 wt % Sn has too large difference between the solidus and liquidus temperatures, whereby a consistent fusing cannot be obtained. On the other hand, the fusible alloy containing more-than 50 wt % Sn loses softness; such an alloy is too fragile to be processed into a fuse wire due to its poor flexibility.

In is more expensive than Sn; decreasing the percentage of In than that of Sn contributes to a low production cost. To achieve the target fusing temperature, Bi is mixed for the balance of the composition of In and Sn.

With the composition ratio described above, the first fusible alloy having the target temperature of approx. 133° C., more specifically, the fusing temperature in the range of 128° C. to 138° C. can be obtained.

The aforementioned inevitable impurities represent other elements that cannot be thoroughly shut out from being mixed into the alloy through the manufacturing processes, or oxides generated while the alloy fuses. For example, aluminum (Al), silver (Ag), antimony (Sb), arsenic (As), iron (Fe), copper (Cu), lead (Pb) can be the inevitable impurities.

Hereinafter will be described the experiment in which a thermal fuse is formed of the first fusible alloy as a sample. Showing the result of the experiment will clarify the characteristics of the fusible alloy of the present invention.

(Experiment 1)

According to composition ratio predetermined by each sample, a first fusible alloy was prepared and then employed for the fuse element of a thermal fuse of each sample.

In preparing the samples, In of at least 99.99% purity, Sn of at least 99.99% purity, and Bi of at least 99.99% purity were weighed according to the percentage by weight determined by each sample and then melted in a fusing furnace. The metals were kept in the furnace until each metal completely melted. In an advanced state of fusing, the mixture was well stirred to obtain an alloy having uniform distribution in composition. After being stirred well and completely fused, the mixture was slowly cooled at room temperature. Through the process above, each sample was obtained. For each fusible alloy, the liquidus and the solidus temperatures and the difference between the two temperatures were measured and evaluated whether or not each sample provides a desired fusing temperature and fusing characteristics. The measurements were performed with the differential scanning calorimeter (DSC) made by Seiko Instruments Corp.

As shown in Table 1, samples 1 through 11 were formed from the first fusible alloy according to the following composition ratio: 2.5-9.0 wt % In, 40-55 wt % Sn and 41.0-57.5 wt % Bi. All the samples prepared were evaluated by using the DSC. Table 1 shows results of the experiment, containing liquidus temperature; solidus temperature; difference between the liquidus and solidus temperatures (hereinafter, temperature difference); remarks; and evaluation.

As for the liquidus temperature, judgment was done whether or not a sample has the liquidus temperature in the desired range of 128° C. to 138° C. Each sample was further tested on the range of the temperature difference and variations in fusing temperature. All things considered, the samples were finally judged as “OK” or “NG”. As for the sample given “NG”, the table gives the reason in the “remarks” column.

In Table 1, the sample that totally achieved good results based on the aforementioned evaluation on the liquidus temperature, temperature difference, variations in fusing and others was concluded to be “OK”; otherwise, judged as “NG”. As shown in Table 1, Samples 2 through 6 out of the 11 samples shown in Table 1 were judged “OK”, and the rest were judged “NG”.

TABLE 1

| | | | | Measurements by | | | | |
|---|---|---|---|---|---|---|---|---|
| | Composition | | | DSC | | | | |
| | ratio | | | (° C.) | | | | |
| | (wt %) | | | Liquidus | Solidus | Temp. | | Final |
| | In | Sn | Bi | temp. | temp. | difference | Remarks | judgment |
| Sample 1 | 2.5 | 40.0 | 57.5 | 135.2 | 124.33 | 10.87 | Wide variations | NG |
| | | | | | | | of the fusing | |
| | | | | | | | characteristics | |
| Sample 2 | 2.5 | 43.5 | 54.0 | 135.49 | 124.72 | 10.77 | none | OK |
| Sample 3 | 2.5 | 50.0 | 47.5 | 135.34 | 123.71 | 11.63 | none | OK |
| Sample 4 | 5.0 | 43.5 | 51.5 | 129.4 | 111.7 | 17.7 | none | OK |
| Sample 5 | 5.0 | 48.0 | 47.0 | 128.9 | 111.9 | 17 | none | OK |
| Sample 6 | 5.0 | 50.0 | 45.0 | 130.3 | 110.5 | 19.8 | none | OK |
| Sample 7 | 6.0 | 48.0 | 46.0 | 126.1 | 104.5 | 21.6 | Temp. difference of | NG |
| | | | | | | | 20° C. or larger. | |
| | | | | | | | Wide variations. | |
| Sample 8 | 9.0 | 48.0 | 43.0 | 115.7 | 98.5 | 17.2 | Two or more peaks | NG |
| | | | | | | | in the temp. curve. | |
| Sample 9 | 6.0 | 50.0 | 44.0 | 125.9 | 105.3 | 20.6 | Temp. difference of | NG |
| | | | | | | | 20° C. or larger. | |
| | | | | | | | Wide variations. | |
| Sample | 9.0 | 50.0 | 41.0 | 117 | 98.6 | 18.4 | Two or more peaks | NG |
| 10 | | | | | | | in the temp. curve. | |
| Sample | 2.5 | 55.0 | 42.5 | 134.77 | 123.71 | 11.06 | A wire processed | NG |
| 11 | | | | | | | from this cannot be | |
| | | | | | | | reeled due to lack | |
| | | | | | | | of flexibility. | |

The result of Table 1 shows that Sample 1 has an insufficient amount of Sn. Samples 7 through 10 have too-low liquidus temperatures due to the high composition ratio of In. Besides, Samples 7 through 10 exhibit wide variations in the fusing condition due to the too large temperature difference. It is thus apparent that the fusible alloy having a fusing temperature in the range of 128-138° C. cannot be obtained from the samples above. In addition, Sample 11 has a demerit of poor workability due to high composition ratio of Sn.

On the other hand, the results show that Samples 2 through 6 have a fusing temperature in the range of 128-138° C. In a ternary (In—Sn—Bi) alloy, determining the composition range of the three elements obtains the first fusible alloy optimally employed for a thermal fuse that fuses at a desired temperature, i.e., around 133° C.

The evaluation above proved that the first fusible alloy of the present invention, which contains 0.1-5 wt % In, 43.5-50 wt % Sn, and the balance being Bi and inevitable impurities, is a desired fusible alloy having a fusing temperature in the range of 128-138° C.

Second Exemplary Embodiment

FIGS. 2 through 5 illustrate the fuse section of the second embodiment of the present invention.

Fuse element 1 is formed of the first fusible alloy described in the first embodiment. Although FIG. 2 shows substantially linear fuse element 1, it is not limited thereto; the fuse element can be formed into various shapes, for example, a plate or oval shape. Fuse element 1 is the section that actually fuses in a thermal fuse (will be described later), and the essential part of determining the operating temperature of the thermal fuse.

Here will be described an example of manufacturing fuse element 1. After fusing an alloy having a predetermined composition ratio of elements, inject the melted alloy into a casting cylinder, and then cool it to obtain a solid state. With the application of high pressure, extrude the solidified cylindrical alloy, through an extruder or the like, to form into a wire. Then, the alloy wire is cut to a predetermined length to complete a fuse element.

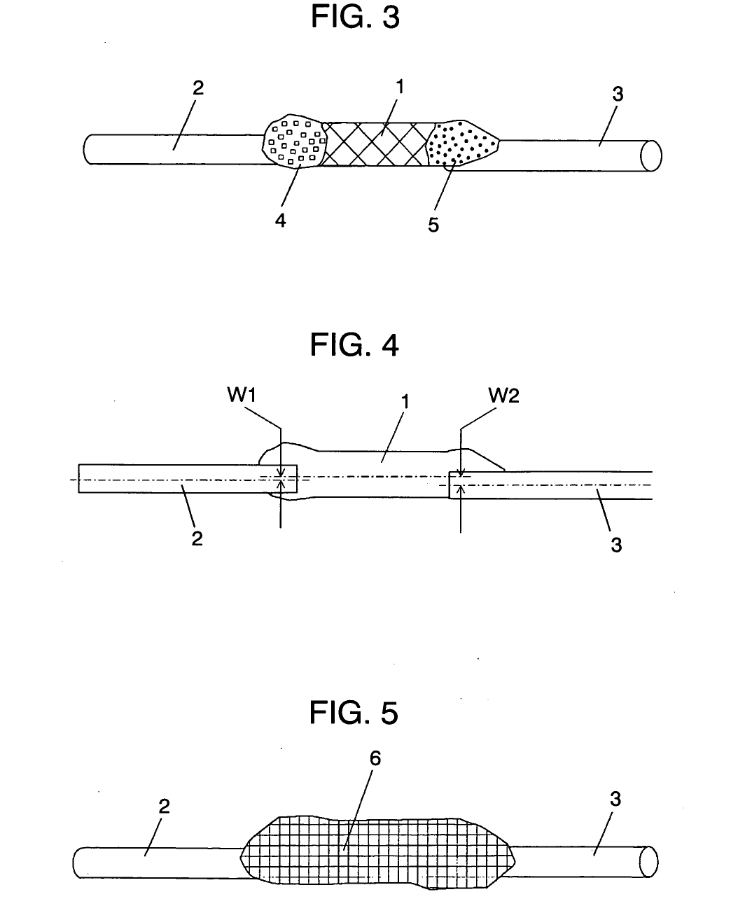

Lead terminals 2 and 3 are connected with both ends of linear fuse element 1. As shown in FIG. 3, connecting electric terminals 2 and 3, through thermally joint sections 4 and 5, respectively, to both ends of fuse element 1 establishes electrical connections between terminals 2, 3 and fuse element 1. Electric terminals 2 and 3 are preferably made of metal; specifically, the terminals should be formed of at least any one of the metal group that consists of iron, nickel, copper, aluminum, gold, silver, and tin; or an alloy of them. Furthermore, the terminals may be a metallic material in which an element other than the aforementioned metal group is mixed with at least a single metal or an alloy of the metal group.

Here will be described how to connect fuse element 1 to electric terminals 2 and 3. A weld metal is contacted with the joint portions between fuse element 1 and electric terminals 2, 3. When an electric current passes through terminals 2 and 3, generated heat melts the weld metal, so that the fuse element and the terminals are connected. FIG. 4 is a sectional view of the fuse section. W1 shows the difference between the central axes of fuse element 1 and electric terminal 2, while W2 shows the difference between the central axes of fuse element 1 and electric terminal 3. As shown in FIG. 4, W2 keeps a predetermined distance, whereas W1 measures a distance close to zero.

Electric terminals 2 and 3 are given plating on each surface. When the plated surfaces and the fusible alloy make contact in larger area, a higher fusing effect is expected. It is therefore preferable that electric terminals 2 and 3 are connected to fuse element 1 so that each central axis is shifted from that of fuse element 1.

FIG. 5 shows flux 6 disposed around fuse element 1. In such structured fuse in the actual use, when temperature rise exceeds a level, flux 6 starts melting earlier, because of its lower fusing temperature, than fuse element 1. The surface tension of fused and liquefied flux 6 allows fuse element 1 to have an effective separation. Flux 6 should preferably be mainly made of rosin. Further, the thermal fuse should preferably employ colored flux disposed in a case having a transparency (which will be described later), so that the amount of flux can be easily observed through the case. With the colored flux and the case having a transparency, discrimination between defective or good can be automatically evaluated by image recognition. This contributes to a low-cost inspection on the quality of products.

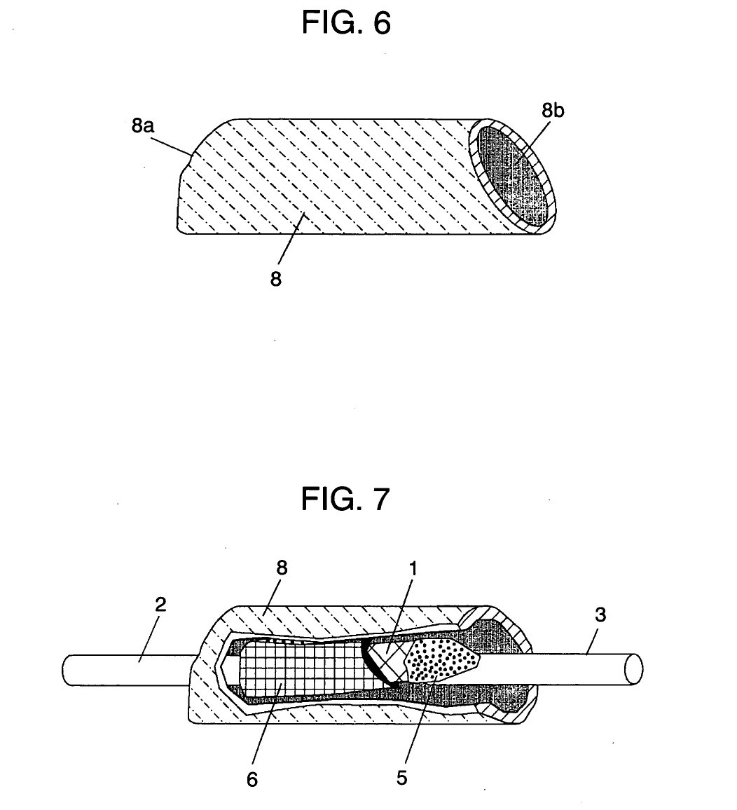

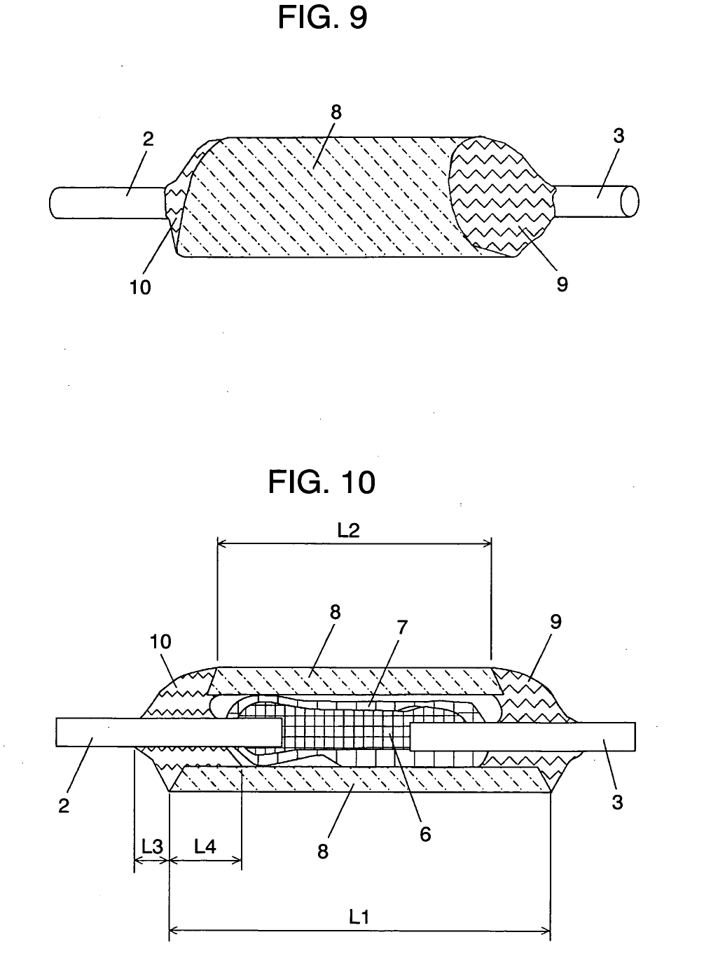

Now will be described a thermal fuse containing fuse element 1 in the case, particularly, a structural merit of the case in which both ends face not parallel with each other and each end is not vertical with respect to the lengthwise surface of the case, with reference to FIGS. 6 through 14.

FIGS. 6 through 11 show an axial-type thermal fuse.

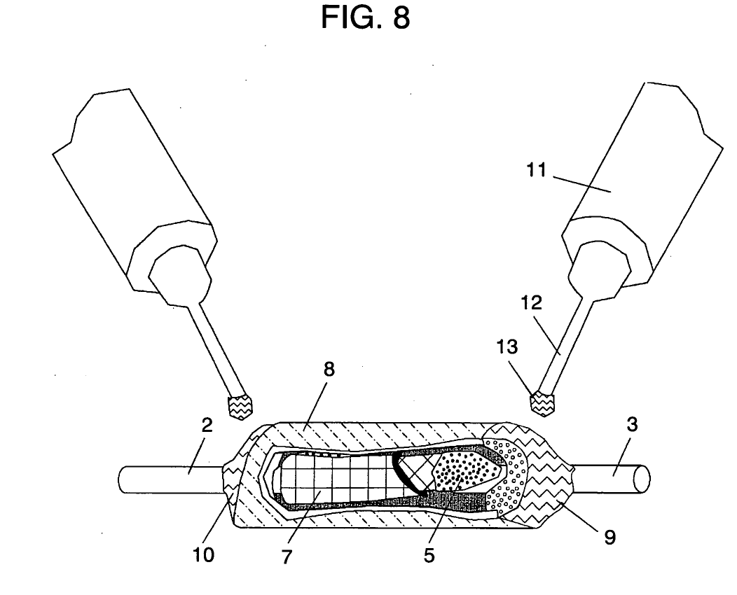

Case 8 has openings 8a and 8b at its both ends. Openings 8a and 8b are to be sealed with sealer 9 and 10. FIG. 8 shows dispenser 11, with sealer 13 being stuck to needle tip 12. Case 8 is designed for an axial-type fuse and the electric terminals extend through the openings disposed at both ends of the case.

Both the ends confront in not parallel with each other, and each end is not vertical with respect to the lengthwise direction of case 8. In other words, the openings of case 8 have a structure in which at least one opening end is beveled at an angle with respect to a virtual plane that is vertical to a protruding direction of the electric terminal. As shown in FIG. 6, case 8 is substantially formed into a trapezoid in section. The trapezoidal section of the case contains the maximum length and the minimum length of the sides in the lengthwise direction of the case. Fuse element 1 is inserted through openings 8a and 8b of both ends of case 8. After that, sealing openings 8a and 8b with sealer completes a thermal fuse. FIG. 7 shows case 8 in which fuse element 1, flux 6, and a part of electric terminals 2 and 3 are accommodated. As shown in the figure, openings 8a and 8b of case 8 are beveled ends with respect to the lengthwise direction of the case.

FIG. 8 shows the sealing process at openings 8a and 8b. Sealer 9 is fed from dispenser 11. Dispenser 11 is usually used for extruding sealer made of resin or the like in the sealing process. If case 8 had a structure like the prior-art one-both ends of case 8 is formed vertical to the lengthwise direction of the case, the sealing work would not be easy, because a worker has to horizontally hold dispenser 11 and insert tip 12 of the dispenser from the side direction to apply sealer 9 to the opening. Besides, tip 12 inserted through an opening could thermally affect the interior-disposed components including fuse element 1, electric terminals 2, 3, and the thermally adhesive material for connecting them. Furthermore, sealer 9, 10—which is tend to be fed too-much from dispenser 11 because of its inappropriate applying direction-spills out from each opening. As for sealer 9 and 10, resins are mainly used from the advantages of processing with ease and low material cost. Resins have a high thermal coefficient of expansion. If a thermal fuse is heated, with large amounts of resin sealer 9(10) spilled out around the openings, the resin stuck to the case thermally expands and can alter the shape of the openings, thereby degrading the characteristics of the fuse. As another possible problem, the spilled-out sealer causes stress on electric terminals 2 and 3, so that electric terminals 2 and 3 are degraded, or the thermally joint section between fuse element and the electric terminals is subjected to the stress carried from the electric terminals.

In contrast, according to case 8 of the embodiment having beveled openings, a worker can perform the sealing process, holding tip 12 of dispenser 11 nearly vertical to the lengthwise direction of case 8. The almost straight-down positioning of dispenser 11 improves the sealing process and simplifies the manufacturing processes, reducing inconsistency in quality of elements and production costs. As another advantage, air bubbles in the sealer can be suppressed.

Besides, as compared to the prior art structure, the amount of sealer can be saved, and therefore spillover of sealer can be minimized. As described above, in the case that resin-made sealer spills over the outside of the case in a considerable amount, the spillover expands or contracts in response to changes in temperature, thereby causing undesired stress on case 8, electric terminals 2 and 3. As a result, fusing characteristics or performance of the element may be degraded. On the contrary, according to the case having beveled openings of the present invention, the sealing process completes in less time or fewer procedures, and the spillover of the sealer is minimized. That is, the stress, which has been caused by the thermally expanded sealer, on electric terminals 2, 3 and case 8 can be suppressed, whereby an ill effect on fusing characteristics can be reduced. Such advantages also protect the thermal fuse from element degradation, and enhance durability of the fuse.

FIG. 10 shows a side sectional view of a thermal fuse after the completion of the sealing process. In the figure, L1 indicates the maximum length of the case 8, and L2 indicates the minimum length of the case. Case 8 having the beveled ends has the maximum length and the minimum length in the lengthwise direction of the case. L3 indicates an extrusion length with respect to the end of the case having maximum length L1 when the both ends of the case are sealed; on the other hand, L4 indicates an intrusion length, of which sealer 10 gets into the interior of the case, with respect to the end of the case having the maximum length L1. Forming case 8 so as to have beveled both ends, as shown in FIG. 10, can suppress spillover of sealer outside the case, i.e., intrusion length L4 is larger than extrusion length L3. Realizing L4>L3 protects the fuse element and other components from undesired thermal effects caused by sealer that has a high coefficient of expansion, thereby minimizing element degradation.

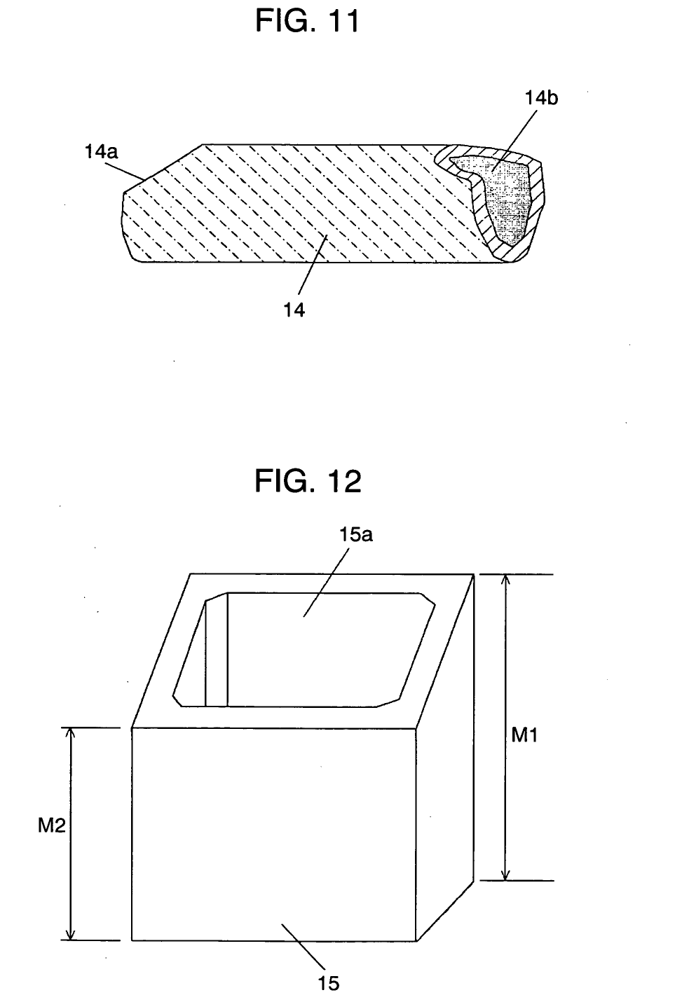

Case 14 shown in FIG. 11 has notches 14a and 14b each in both ends. Forming notches 14a, 14b is further effective in suppressing the spillover of sealer outside the openings of the case. The structure with notches can keep, with reliability, L4 to be larger than L3, which is further effective in reducing the undesirable effects on the element due to thermal expansion of the sealer including resin. Notches 14a and 14b should preferably be disposed, as shown in FIG. 11, in a part of the case. Preferably, notches 14a and 14b should be positioned so that needle tip 12 of dispenser 11 fits each notch when the sealer is applied in the sealing work.

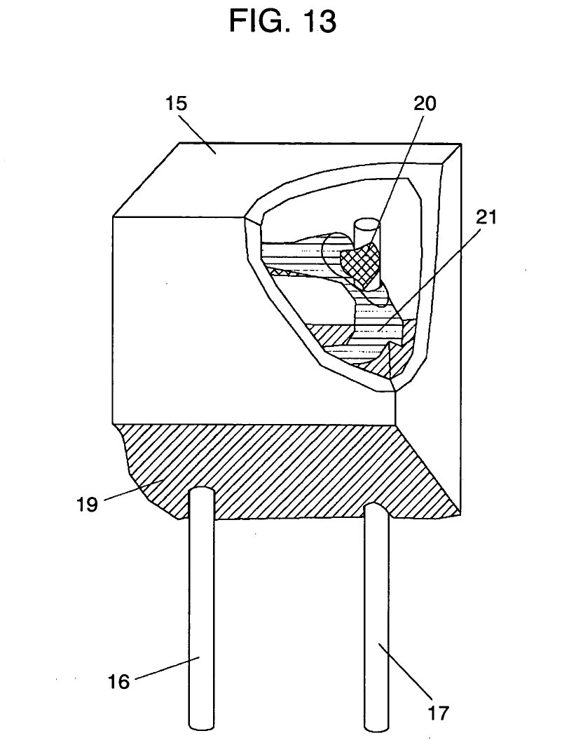

FIG. 13 is a perspective view illustrating the inner structure of a radial-type thermal fuse. Two electric terminals 16 and 17 protrude from opening 15a. Opening 15a is sealed with sealer 19. Flux 21 covers fuse element 20 made of the first fusible alloy described in the first embodiment to enhance proper separation of the melted fuse element.

Case 15 has beveled opening 15a, as shown in FIG. 12, so that the structure has minimum length M2 and maximum length M1 of the sides. The side section of case 15 is look like a trapezoid. Fuse element 20 and other necessary components are housed into case 15 having minimum length M2 and maximum length M1, and then opening 15a is sealed with sealer 19 made of resin or the like. A thermal fuse is thus completed. The shape of the end shown in FIG. 12 is an example of the structure in which at least one opening end is beveled at an angle with respect to a virtual plane that is vertical to a protruding direction of the electric terminal.

By virtue of beveled opening 15a, a worker can easily apply the sealer from outside the case, with no need of inserting needle tip 12 of dispenser 11 into the interior of the case. This can simplify and speed up the sealing process. In contrast, according to the conventional structure in which the opening is formed vertical to the lengthwise direction of the case, a worker had to apply the sealer by inserting needle tip 12 of dispenser 11 inwardly from the opening, and carefully perform the sealing with taking time so that the opening is thoroughly and uniformly sealed with the sealer. The sealer has often spilled over outside the case and thermally expanded spillover could cause undesired effect.

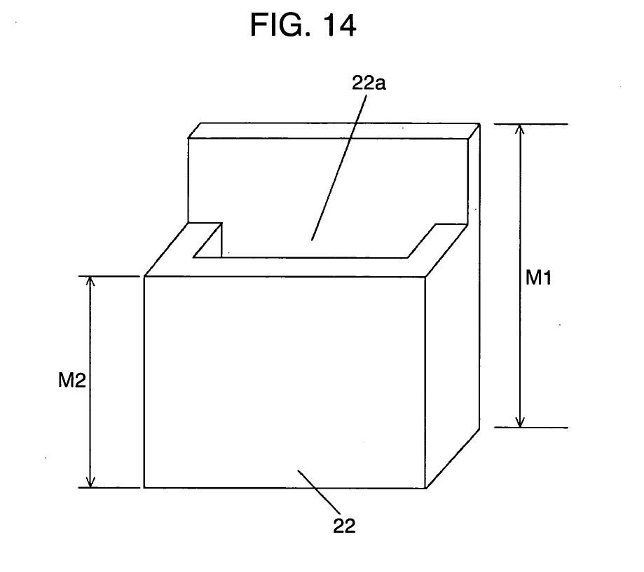

FIG. 14 shows another structure of the case of a radial-type thermal fuse. Case 22 has stepped opening 22a. Like case 15 shown in FIG. 12, case 22 has minimum length M2 and maximum length M1. Case 22 has a shape different from conventional structures substantially formed into a rectangular parallelepiped or a cube.

With the case having stepped opening 22a, a worker can also easily apply the sealer outside the case, with no need of inserting needle tip 12 into the inside of the case. Therefore, the undesirable effect caused by thermal expansion of the sealer can be suppressed, and sealing time can be accelerated.

Forming the case of the thermal fuse so as to have the minimum length and the maximum length in the sides of the case, or so as to have a trapezoidal shape in a side section of the case can simplify the sealing work on the opening, accordingly, can shorten the time for the sealing work. These merits contribute to an improved sealing with reliability and yield-enhanced production, which further increases performance of the thermal fuse and achieves low production cost. Besides, such structured case prevents sealer from spilling over outside the case, thereby reducing stress on the case and the electric terminals caused by thermal expansion of resin sealer. The fusible alloy described in the first embodiment can be formed into a highly durable thermal fuse with no ill effect on fusing characteristics and no degradation of the element. In this way, a thermal fuse that fuses at around 133° C., and therefore suitable for a battery charger and an adaptor, can be obtained.

The opening of the case, through which the electric terminals protrude, has the structure in which at least one opening end is beveled at an angle with respect to a virtual plane that is vertical to a protruding direction of the electric terminal. As an example of the shape, the first and the second embodiments introduce the following structures: an opening end obtained by diagonally cutting a cylindrical case (FIG. 6) or a rectangular parallelepiped case (FIG. 12); a notch-disposed opening end (FIG. 11); and a stepped opening end (FIG. 14). The aforementioned stepped opening end is included in the structure in which at least one opening end is beveled at an angle with respect to a virtual plane that is vertical to a protruding direction of the electric terminal. The scope of the present invention includes not only the structures introduced above, but also the opening-end structure designed for applying sealer easily.

The explanation given in the second embodiment focuses on an axial-type thermal fuse and a radial-type thermal fuse. The present invention can also applied to a slim-type thermal fuse formed of a substrate film; a pair of electric terminals disposed on the film; a fuse element made of the fusible alloy described in the first embodiment and disposed across the electric terminals; and a cover film. Employing the fusible alloy explained in the first embodiment allows the thermal fuse to operate at around 133° C. suitable for a power supply and an adapter. The fuse has the structure optimal for mounting on, for example, an assembled cell. Other than that, the thermal fuse of the present invention can be fixed in various kinds of electric devices, such as light equipment, a heating device including electric foot warmer, a measuring device that undergoes a steep rise in temperature.

The thermal fuse of the present invention has the structure in which both the confronting ends of the case are not parallel with each other, and each end is not vertical with respect to the lengthwise direction of the case. That is, the case of the fuse has beveled openings at its both ends. Such formed openings can be easily sealed with a dispenser, whereby the sealing process is simplified; accordingly, variations in quality of elements can be decreased. These advantages enhance reliability and durability of sealing condition.

In addition, controlling the intrusion amount of the sealer can protect the fuse element in the case from having an undesired effect caused by thermal expansion of the sealer.

The thermal fuse of the second embodiment is formed of the first fusible alloy—free from environmentally hazardous elements, such as Pb—having a fusing temperature in the range of 128-138° C. Employing the aforementioned fusible alloy can form a thermal fuse with higher durability and fewer variations in quality of products.

Third Exemplary Embodiment

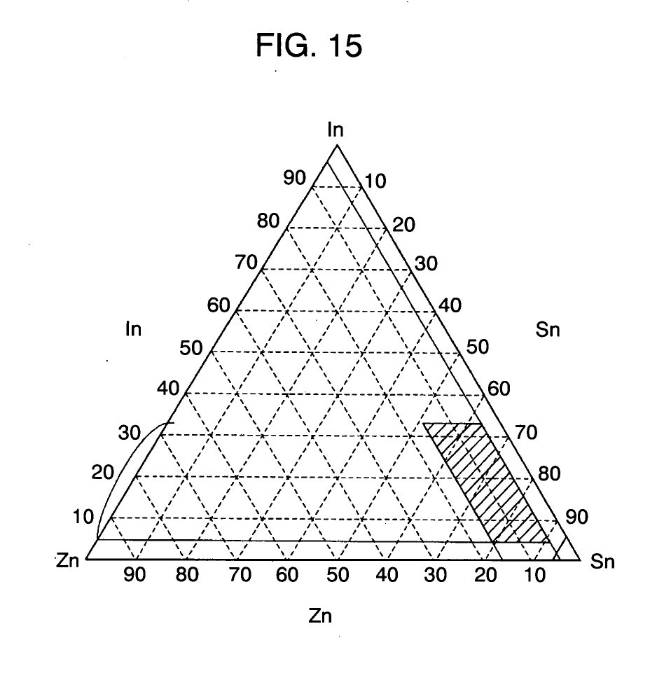

FIG. 15 is a ternary composition diagram of the fusible alloy of the third embodiment. FIG. 15 shows compositional relationship of indium (In), tin (Sn), and zinc (Zn). Each side of the triangle of FIG. 15 bears percent by weight of each element. The scale on the base of the triangle is for the percent by weight of Zn; the scales on the right and left sides are for Sn and In, respectively. In the triangle, each value of wt % is connected by broken lines. The diagonally shaded area indicated by solid lines is the area that satisfies the composition ratio of the second fusible alloy of the present invention.

The second fusible alloy of the present invention is a ternary alloy formed of indium (In), tin (Sn), and zinc (Zn) except for inevitable impurities. The reason why the three elements of In, Sn and Zn are used will be described hereinafter. As the reason why In and Sn are used has already discussed in the first embodiment, here will be given the explanation on Zn.

Compared to Bi that has often been used for a conventional fusible alloy, Zn has a minor effect of reducing a melting point of a fusible alloy. Therefore, Zn is a suitable element for forming a fusible alloy required to have relatively high fusing temperatures of 160-190° C. On the other hand, Bi contained alloy is difficult to achieve the aimed fusing temperature because Bi lowers the fusing temperature of a fusible alloy. In contrast, Zn has no problem about that due to its mild contribution to lowering the fusing temperature of a fusible alloy.

Next will be described the reason why the composition ratio of the second fusible alloy of the present invention is determined to the following ranges: 5-33 wt % In; 4.7-15.5 wt % Zn; and the balance being Sn and inevitable impurities.

First, the reason for mixing 5-33 wt % In is described. In the fusible alloy containing less than 5 wt % In, the advantage of In—decreasing the melting point of a fusible alloy—does not sufficiently work, so that the liquidus temperature of the fusible alloy exceeds 190° C. no matter how the composition ratio of the rest elements are changed. Therefore, at-least 5 wt % In is indispensable for achieving the target temperature of 160-190° C. On the other hand, in the fusible alloy containing more than 33 wt % In, the fusible alloy has too low liquidus temperature: below 160° C. Accordingly, the fusing temperature that lies between the solidus and liquidus temperatures cannot reach 160° C. That is, the fusing temperature cannot achieve the target value of 160-190° C. From the reason above, the composition ratio of In is determined to be 5-33 wt %. In the case that the fusible alloy contains large amount of In, inconveniency occurs—when the fusible alloy is processed into a wire-like shape, they have a tendency of sticking each other. To avoid the problem, the composition ratio of In is required to be at most 33 wt %. Furthermore, In is more expensive than the rest elements of the fusible alloy, therefore, defining a too-high ratio of In increases the manufacturing cost. In terms of low cost production, the composition ratio of In should preferably be kept low.

More preferably, the fusible alloy should contain 9-15 wt % In. The experiment result below shows that employing the ratio of In can make temperature difference between the solidus and liquidus small, decreasing variations in fusing temperatures. Accordingly, it enhances the fusing characteristics of the fuse element formed of the fusible alloy. However, employing the composition ratio of 5-33 wt % In can provide the fusible alloy with the target fusing temperature of 160-190° C.

Next will be described the reason why Zn content of 4.7-15.5 wt % is preferable. The fusible alloy containing Zn, in a proper balance with In that decreases the fusing temperature, can achieve the target fusing temperature of 160-190° C. If the fusible alloy contains Zn less than 4.7 wt %, the fusing temperature curve of the alloy has two peaks—fluctuation of the fusing temperature may result. Using a fusible alloy having two peaks in its fusing temperature curve will cause a defective fuse that operates at unintended temperature, thereby degrading the reliability for practical use. As another demerit of less than-4.7 wt % Zn, the temperature difference between the solidus and liquidus becomes large, which increases variations in the fusing condition of the fuse. This also invites degradation of reliability. It is therefore necessary to have Zn at least 4.7 wt %.

On the other hand, if the fusible alloy contains Zn more than 15.5 wt %, the fusing temperature decreases too low to fuse at the target temperature of 160-190° C. It will be understood that a thermal fuse formed from such an alloy cannot achieve the target fusing temperature as a practical fuse. The composition ratio of Zn is thus optimally defined in the range from 4.7 to 15.5 wt %.

Now will be described Sn. Sn is effective in enhancing the mixture of metallic elements and improving the wettability of a fusing alloy, rather than having an effect directly on the fusing temperature. Sn is contained in the fusible alloy so as to make up the rest of the composition ratio of In and Zn. That is, from the composition ratio of 5-33 wt % In and 4.7-15.5 wt % Zn, the composition ratio of Sn is automatically determined to be 51.5-90.3 wt %. Sn is less expensive than In. Taking it into account, determining the composition ratio of Sn so as to be higher than that of In contributes to a cost decreased fusible alloy and thermal fuse.

As described above, by employing the composition ratio of 5-33 wt % In; 4.7-15.5 wt % Zn; the balance being Sn and inevitable impurities, the second fusible alloy that fuses at a target temperature of 160-190° C. can be obtained.

The aforementioned inevitable impurities represent other elements that cannot be thoroughly shut out from being mixed into the alloy through the manufacturing processes, or oxides generated while the alloy fuses. For example, aluminum (Al), silver (Ag), antimony (Sb), arsenic (As), iron (Fe), copper (Cu), lead (Pb), and bismuth (Bi) can be the inevitable impurities.

Hereinafter will be described the experiment in which a thermal fuse was formed of the second fusible alloy as a sample. Showing the result of the experiment will clarify the characteristics of the fusible alloy of the present invention.

(Experiment 2) According to composition ratio predetermined by each sample, a second fusible alloy was prepared and then employed for the fuse element of a thermal fuse of each sample.

In preparing the samples, In of at least 99.99% purity, Sn of at least 99.99% purity, and Zn of at least 99.99% purity were weighed according to the percentage by weight determined by each sample and then melted in a fusing furnace. The three metals were kept in the furnace, with the temperature maintained 350° C. or higher, until each metal completely melted. In an advanced state of melting, the mixture was well stirred to obtain an alloy having uniform distribution in composition. After being well stirred and completely fused, the mixture was slowly cooled at room temperature. Through the process above, each sample of the second fusible alloy was obtained. For each sample of the fusible alloy, the liquidus and the solidus temperatures and the difference between the two temperatures were measured and evaluated whether or not each sample provides a desired fusing temperature and fusing characteristics. The measurements were performed with the differential scanning calorimeter (DSC) made by Seiko Instruments Corp.

As shown in Table 2, samples 1 through 20 were formed from the second fusible alloy according to the following composition ratio: 27.9-90.8 wt % Sn, 2.26-17.0 wt % Zn, and 3.1-62.1 wt % In. Table 2 shows results of the experiment, containing liquidus temperature; solidus temperature; evaluation on the liquidus temperature; difference between the liquidus and solidus temperatures (hereinafter, temperature difference); evaluation on the temperature difference (smaller than 35° C.); and final evaluation.

As for the liquidus temperature, judgment was done whether or not a sample has the liquidus temperature in the range of 160° C. to 190° C. If a sample has the liquidus temperature within the range, the sample was given “OK”, otherwise, given “NG”. Next, the evaluation on the temperature difference was done whether the difference satisfies a predetermined value or not; the difference less than 35° C. was judged “OK”, whereas the difference of 35° C. or greater was judged “NG” for each sample. If a sample has the liquidus temperature in the target range of 160-190° C, the fact is necessary but not sufficient to win the final judgment of “OK”. It is because that, since a fusing temperature is found between the solidus and liquidus temperatures, too large temperature difference causes variations in fusing temperature, thereby seriously degrading the quality of the fusing alloy and the fusing characteristics of a fuse element formed of the alloy. Therefore, samples having the liquidus temperature in the range of 160-190° C. cannot always be the fusible alloy having fusing characteristics as intended.

As described above, an fusible alloy has its fusing temperature between the liquidus and solidus temperature. In the fusible alloy that satisfies the temperature range of 160-190° C., the fusing temperature is surely found within the temperature difference of 30° C. The criterion for judgment—less than 35° C.—was determined in light of the temperature difference (i.e., 30° C.) and the fact that a fusible alloy has a fusing temperature at somewhere—fairly closer to the liquidus temperature—between the solidus and liquidus temperatures. In this way, in the case that the temperature difference is less than 35° C., the sample was given “OK” as a fusible alloy with satisfactory fusing characteristics.

TABLE 2

| | | | | Measurement by DSC | | | | | |
|---|---|---|---|---|---|---|---|---|---|
| | | | | (° C.) | | | | | |
| | Composition ratio | | | | | Liquidus | | Less | |
| | (wt %) | | | Liquidus | Solidus | temp. is | Temp. | than | Final |
| | Sn | Zn | In | temp. | temp. | satisfied? | difference | 35° C.? | evaluation |
| Sample 1 | 42 | 8.2 | 49.8 | 108.9 | 106.5 | NG | 2.4 | OK | NG |
| Sample 2 | 47.4 | 11.5 | 41.1 | 111.2 | 106.4 | NG | 4.8 | OK | NG |
| Sample 3 | 27.9 | 10 | 62.1 | 118.7 | 112.1 | NG | 6.6 | OK | NG |
| Sample 4 | 56.7 | 5.3 | 38 | 136.6 | 106.3 | NG | 30.3 | OK | NG |
| Sample 5 | 60.1 | 6.1 | 33.8 | 146.4 | 106.3 | NG | 40.1 | NG | NG |
| Sample 6 | 65.65 | 17 | 20.35 | 167.5 | 121.8 | OK | 45.7 | NG | NG |
| Sample 7 | 74.18 | 4.6 | 21.22 | 168.8 | 122.1 | OK | 46.7 | NG | NG |
| Sample 8 | 68.39 | 9.57 | 22.05 | 166.7 | 134.9 | OK | 31.8 | OK | OK |
| Sample 9 | 74.3 | 8.38 | 17.32 | 175.4 | 143.8 | OK | 31.6 | OK | OK |
| Sample 10 | 77.22 | 5.8 | 16.98 | 176.6 | 145.3 | OK | 31.3 | OK | OK |
| Sample 11 | 69.6 | 15.3 | 15.1 | 179.6 | 164.8 | OK | 14.8 | OK | OK |
| Sample 12 | 76.12 | 10.16 | 13.72 | 180.6 | 155.8 | OK | 24.8 | OK | OK |
| Sample 13 | 82.09 | 4.75 | 13.06 | 181.1 | 164.4 | OK | 16.7 | OK | OK |
| Sample 14 | 79.17 | 7.4 | 13.43 | 181.5 | 159.5 | OK | 22 | OK | OK |
| Sample 15 | 79.77 | 10.64 | 9.59 | 186.8 | 172.2 | OK | 14.6 | OK | OK |
| Sample 16 | 85.86 | 4.97 | 9.8 | 186.6 | 175.3 | OK | 11.3 | OK | OK |
| Sample 17 | 82.88 | 7.74 | 9.38 | 187.2 | 174.9 | OK | 12.3 | OK | OK |
| Sample 18 | 76.91 | 2.26 | 20.83 | 183.5 | 128.8 | OK | 54.7 | NG | NG |
| Sample 19 | 86.96 | 8.12 | 4.92 | 194.6 | 192.8 | NG | 1.8 | OK | NG |
| Sample 20 | 90.8 | 6.1 | 3.1 | 198.5 | 190.3 | NG | 8.2 | OK | NG |

In the final judgment of Table 2, a sample that fulfills both the criteria on the liquidus temperature and the temperature difference was finally given “OK”, otherwise given “NG”. The evaluation result shows that samples 8 through 17 were judged “OK” and the rest were judged “NG”.

Sample 1 contains In of 49.8 wt %. Due to the high composition ratio of In, the factor of In, i.e., the tendency of decreasing a fusing temperature, strongly affected the liquidus temperature. The measured value, 108.9° C. is far below the target fusing temperature. None of samples 2 through 5 can achieve the target fusing temperature. As is the case with sample 1, too high composition ratio of In decreased the liquidus temperature.

Sample 6 contains 17 wt % Zn. By virtue of the relatively high composition ratio, the measured value of liquidus temperature was 167. 5° C., which achieved the target range. However, the temperature difference, 45.7° C. is unacceptably large. Considering to this, it is impossible to say with any certainty whether sample 6 has the fusing temperature in the range of 160-190° C. This is the reason why sample 6 was given “NG” as final evaluation.

On the other hand, samples 7 and 18 contain too low composition ratio of Zn and exhibit too large temperature difference. Both resulted in “NG”.

In samples 19 and 20, the liquidus temperature exceeded 190° C. because of too low composition ratio of In. It is doubtful that the two samples have the fusing temperature in the target range of 160-190° C., resulting in being judged “NG”.

The experiment proved that the fusible alloy prepared with the composition ratio in samples 8 through 18 achieved a desired fusing temperature in the range of 160-190° C.

The experiment results and each sample above have demonstrated that the optimal composition ratio of the second fusible alloy having the desired fusing temperature (160-190° C.) is 51.5-90.3 wt % Sn; 4.7-15.5 wt % Zn; and 5-33wt % In.

Fourth Exemplary Embodiment

FIG. 16 illustrates the manufacturing process of the fuse element of a fourth embodiment.

The fuse element is formed of the second fusible alloy described in the third embodiment. Although FIG. 16 shows a plate-like fuse element as an example, the fuse element can be formed into, for example, a linear or oval shape.

The fuse element of the embodiment is made of the second fusible alloy. A fuse element is the essential part of a thermal fuse, which determines the operating temperature of the fuse by fusing.

Manufacturing process 161 has casting step 162, billet-forming step 163, round wire-extruding step 164, squeezing step 165. In casting step 162, melted fusible alloy 176 is poured into casting cylinder 177 and then cooled. In billet-forming step 163, cylindrical billet 178 is taken out of casting cylinder 177. In round wire-extruding step 164, cylindrical billet 178 is now processed into round-wire fusible alloy 181 by extruding. In squeezing step 165, round-wire fusible alloy 181 is further processed into a flat and thin plate by squeeze roller 182. Through the processes above, fusible alloy plate 183 is obtained.

Prior to the manufacturing process, the second fusible alloy having the composition ratio described in the third embodiment is melted by the application of heat to obtain melted fusible alloy 176. Melted fusible alloy 176 is poured into casting cylinder 177. After cooled, fusible alloy 176 is taken out as cylindrical billet 178 from casting cylinder 177. Billet 178 is then put into extruder 179. With the application of high pressure, billet 178 is formed into a round-wire through die 180 of extruder 179. Round-wire fusible alloy 181 is thus obtained. Round-wire fusible alloy 181 is then processed into a plate of fusible alloy 183 by squeeze roller 182. Alloy plate 183 is cut into a predetermined size for a fuse element. After the cutting process, the rectangular parallelepiped piece may be chamfered, or may be cut the corners to form into a polygon or oval shape. According to the thickness required for the fuse element, the gap between the rollers and the pressure level of squeeze roller 182 should be controlled.

Through the processes above, the second fusible alloy having the composition ratio described in the third embodiment is formed into a fuse element for a thermal fuse.

Such manufactured fuse element, since it is made of the second fusible alloy explained in the third embodiment, has desired fusing characteristics, i.e., has a fusing temperature in the range of 160-190° C.

Fifth Exemplary Embodiment

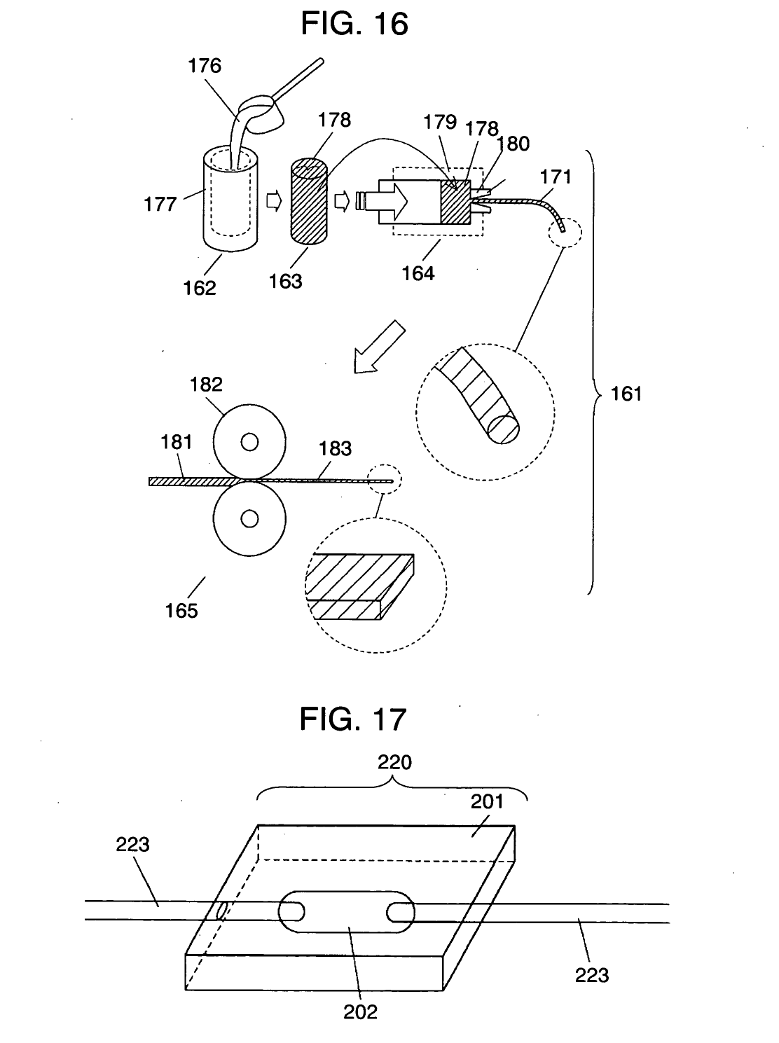

FIG. 17 is a perspective view illustrating an axial-type thermal fuse of a fifth embodiment of the present invention.

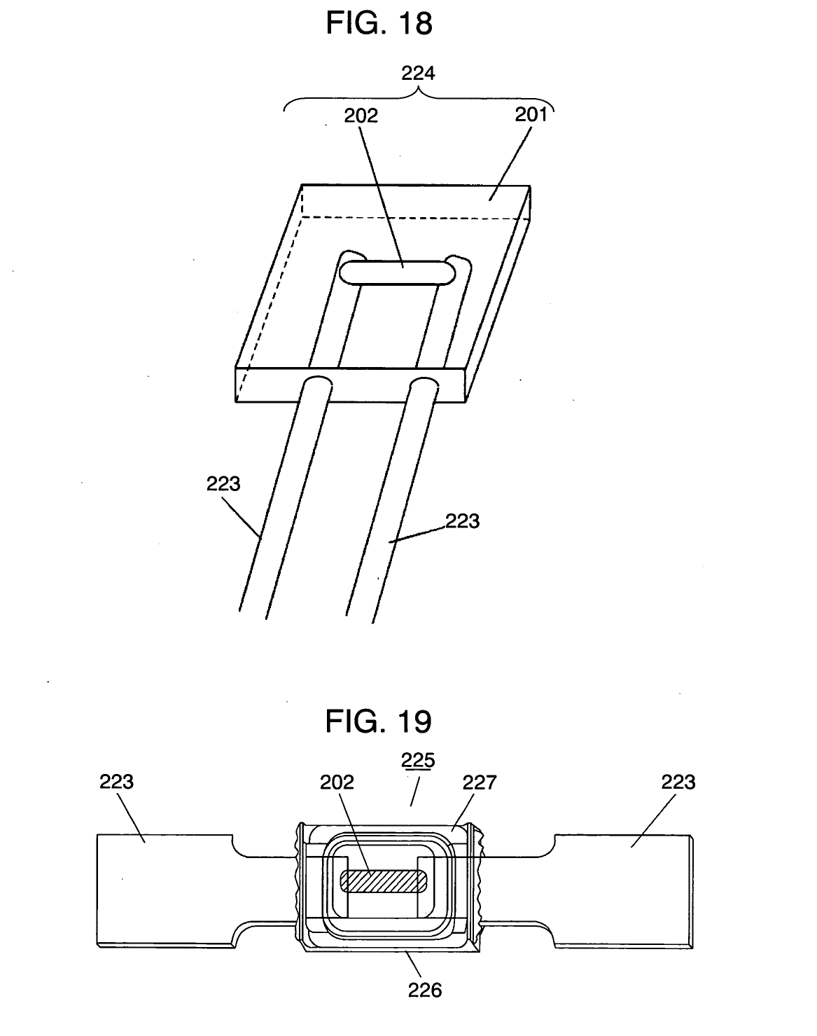

Thermal fuse 220 contains case 201, fuse element 202, and lead terminals 223. Fuse element 202 is made of the second fusible alloy described in the third embodiment, and is manufactured through the processes explained in the fourth embodiment, so that the fuse element fuses at a temperature in the range of 160-190° C. Although FIG. 18 shows fuse element 202 shaped into a plate having arcuate edges, it is not limited thereto; the fuse element can be formed into a linear or rectangular parallelepiped shape.

Lead terminals 223 are connected to a part of a circuit so as to establish electrical connections under normal operating conditions. More specifically, fuse element 202 is made of an electrically conductive fusible alloy and an electric current is driven between the fuse element and each of the lead terminals. Case 201 accommodates fuse element 202 and a part of lead terminals 223. Although FIG. 18 shows the internal part in the interest of clarity, the interior is covered with a case, which is made of resin or the like. Case 201 can be made of a transparent material, a translucent material, or a material with no transparency. Necessary data including a model number and an operating temperature are printed on the surface of case 201 by ultraviolet ink or the like. Lead terminals 223 are made of an electrically conductive material, preferably metal. To be more specific, the terminals should be made of any one of the following options: at least one single element selected from a material group that consists of iron, nickel, copper, aluminum, gold, silver, and tin; an alloy of some of the group; a metallic material in which an element other than the aforementioned material group is added to at least one single element selected from the material group or an alloy of some of the group.

Thermal fuse 220 is fixed to a region that can experience a high rise in temperature, for example, a surface of a battery, or somewhere in an electric circuit or a power supply section of a fluorescent tube and an electric bulb, which are heat-generating regions in lighting equipment. When a battery or circuit in which thermal fuse 220 is fixed generates an unusual heat, due to a short-circuit or other failures, and the temperature reaches as high as the range of 160-190° C., fuse element 202 fuses, since it is made of the second fusible alloy having a fusing temperature in the range. Once fuse element 202 melts, lead terminals 223 no longer have electrical connections with each other. The electrical connections in a circuit that has been established via thermal fuse 220 are shut down; accordingly, further heat generation ceases. The fuse can thus prevent the possibility of damage to the device.

In the case that an unusual temperature rise occurs in a fuse-equipped circuit or component and reaches the target temperature range—where, fuse element 202 has proper characteristics so as to fuse with certainty in the range of 160-190° C., as described in the third and the fourth embodiments, the electrical connections are surely be interrupted. The thermal fuse having an operating temperature in the range of 160-190° C. can be thus realized.

It is necessary that the distance between facing lead terminals 223 is carefully determined so that electrical insulation is maintained at a satisfactory level after fuse element 202 has melted. To facilitate a proper separation of fuse element 202 after fusing, flux mainly made of rosin should preferably be disposed in case 201. As the temperature rises, the flux starts melting earlier than fuse element 202, and the surface tension of melted flux effectively works on the separation of the fuse element.

FIG. 18 is a perspective view of a radial-type thermal fuse of the fifth embodiment of the present invention.

In thermal fuse 224 of FIG. 18, since the fuse has a radial-type structure, lead terminals 223 protrude from the same end of case 201. The structure, being different from the structure of an axial-type, has fuse element 202 disposed at the tip ends of two lead terminals 223 in that case 201. It is therefore suitable for the structure, where a section to which thermal fuse 224 is to be fixed is separated from a circuit. In the case that case 201 accommodating fuse element 202 is fixed to a section to be suffered temperature rise, two lead terminals 223 extending in the same direction can be easily connected to a circuit disposed away from the temperature-rising region. Radial-type thermal fuse 224 is effective, as described above, in the structure having a section to which the fuse is fixed, and a circuit disposed away from the section.

Thermal fuse 224 works similarly to axial-type thermal fuse 220. That is, when. the temperature in a battery or an electric circuit of lighting equipment rises for some reason and reaches the range of 160-190° C., fuse element 202 made of the second fusible alloy melts, thereby two lead terminals 223 are disconnected with each other. The separation breaks down the electrical connections of the circuit and accordingly, further heat generation ceases. The fuse can thus prevent the possibility of damage to the device.

As is described in the axial-type thermal fuse, flux should preferably be contained in case 201 to facilitate a proper separation of fuse element 202.

FIG. 19 is a perspective view of a slim-type thermal fuse of the fifth embodiment.

An advantage of a slim-type thermal fuse, unlike both axial and radial-types, is its extreme thin structure. The slim-type thermal fuse is most suitable for any devices demanding thinner components, such as an assembled cell used for a mobile telephone.

Slim-type thermal fuse 225 contains substrate 226 and cover film 227. To produce thermal fuse 225, first, a pair of lead terminals 223 are bonded onto substrate 226. Next, fuse element 202, which is made of the second fusible alloy described in the third embodiment, is welded on the substrate so as to bridge the pair of lead terminals 223. After that, cover film 227 is disposed on the substrate so as to seal fuse element 202 and a part of lead terminals 223. Prior to the sealing process, flux having rosin as a main component can be disposed in the space between cover film 227 and substrate 226 in order to facilitate a proper separation of fuse element 202 after fusing. Employing a transparent or translucent cover is also preferable; the flux contained in the case can be easily observed through the case. Flux can be colored by controlling the composition of rosin—the main component of flux. With such colored flux, discrimination between defective or good regarding the filled flux can be automatically evaluated by image recognition

Unlike the structure of the axial and radial-types, the slim-type thermal fuse employs thin plate-like read terminals 223, and instead of case 201, employs a substrate and a cover film made of resin, such as polyethylene terephthalate (PET), polyethylene naphthalate (PEN). Therefore, an extremely thin fuse can be obtained.

When slim-type thermal fuse 225 is formed of the second fusible alloy described in the third embodiment, the fuse melts for certain at a temperature in the range of 160-190° C. That is, thermal fuse 225 is optimal for a device that wants no further electrical connections once the temperature rise has reached around 160° C. to 190° C. In the case that fuse element 202 is made of the first fusible alloy described in the first embodiment, slim-type thermal fuse 225 operates for certain at around 133° C.

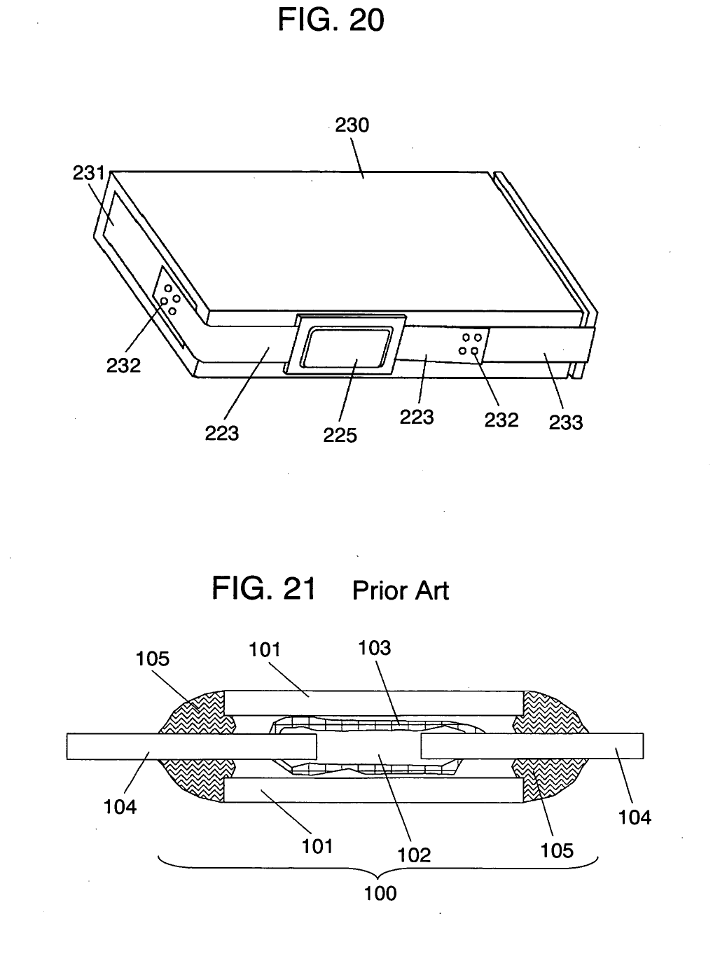

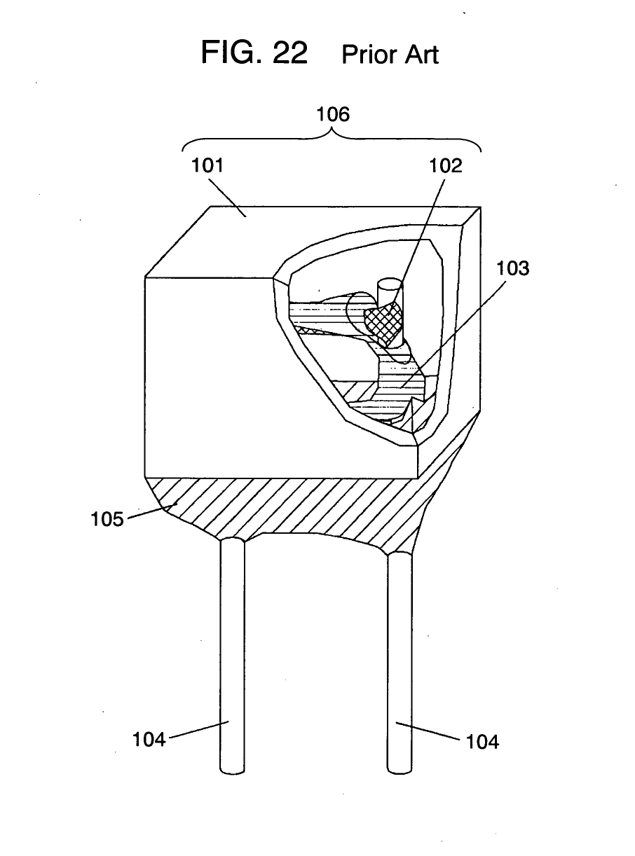

FIG. 20 is a perspective view of an assembled cell introduced in the fifth embodiment of the present invention.

Assembled cell 230 contains terminal 231, weld joints 232, and external output terminal 223. Slim-type thermal fuse 225 is fixed to a side surface of assembled cell 230. Assembled cell 230 has been getting smaller and thinner to satisfy the needs of mobile devices typified by mobile telephones. Rather than the axial or radial types fuse, the slim type fuse is more suitably fitted for such a low profile device.

Terminal 231, which is either the positive terminal or the negative terminal of the assembled cell, is electrically connected to one of lead terminals 223 via weld joints 232. The other one of lead terminals 223 is connected to external output terminal 233 via weld joints 232 so that the power supply of assembled cell 230 is provided to an external circuit. If assembled cell 230 abnormally generates heat and the temperature rises to the range of 160-190° C, fuse element 202 in thermal fuse 225 melts. The melted fuse cuts off the power supply from the assembled cell, preventing the possibility of damage to the device.

Employing the second fusible alloy, which is prepared by the composition ratio of 5-33 wt % In, 4.7-15.5 wt % Zn, the balance being Sn and inevitable impurities, for the fuse element can provide a thermal fuse that reliably operates at a temperature in the range of 160-190° C.

A thermal fuse contains a fuse element formed of a fusible alloy prepared according to the composition ratio of 43.5-50 wt % Sn, 0.1-5 wt % In, and the balance being Bi and inevitable impurities, in order to achieve a fusing temperature at around 133° C.; and a case having the minimum length and the maximum length in the lengthwise direction of the case. Such structured fuse is preferably used for heat generating devices, such as lighting apparatus. The thermal fuse can offer high durability and high yield in the production.

Forming a fusible alloy with the composition ratio of 5-33 wt % In, 4.7-15.5 wt % Zn, and the balance being Sn and inevitable impurities can achieve a higher fusing temperature: 160-190° C. A fuse element formed of the fusible alloy is applicable to an axial-type, a radial-type, or slim-type thermal fuse to get most effective use in various devices. The fuse can prevent the possibility of damage to the device caused by abnormal heat, thereby increasing durability, i.e., lifetime of the device. That is, the repairing cost of the device can be decreased.

1. A thermal fuse comprising:
a fuse element made of fusible alloy;
a first electric terminal and a second electric terminal both of which are connected to the fuse element; and
a case for accommodating at least the fuse element,
wherein, the case has at least one opening end through which the first electric terminal or the second electric terminal protrudes, and the at least one opening end is beveled at an angle with respect to a virtual plane that is vertical to a protruding direction of the electric terminal.

2. A thermal fuse comprising:
a fuse element made of fusible alloy;
a first electric terminal and a second electric terminal both of which are connected to the fuse element; and
a case for accommodating at least the fuse element,
wherein, the case has at least one opening end through which the first electric terminal or the second electric terminal protrudes, and the at least one opening end is not parallel to a virtual plane that is vertical to a protruding direction of the electric terminal.

3. The thermal fuse of claim 1, wherein the case has at least two opening ends, and the fuse has an axial-type structure in which each of the electric terminals protrudes from each of the opening ends.

4. The thermal fuse of claim 1, wherein the case has at least one opening end, the fuse has a radial-type structure in which a plurality of electric terminals protrude from the opening end.

5. The thermal fuse of claim 1, wherein a notch is disposed at least a part of the opening end.

6. The thermal fuse of claim 1, wherein the case includes a first end, through which the first electric terminal protrudes, and a second end, through which the second electric terminal protrudes, and the first end confronts the second end.

7. The thermal fuse of claim 6, wherein the first end is not parallel to the second end.

8. The thermal fuse of claim 6, wherein the first end is not parallel to the second end, and the first end and the second end are not vertical to a protruding direction of the first electric terminal and the second electric terminal.

9. The thermal fuse according to claim 6, wherein the case has a substantially trapezoidal section taken along a protruding direction of the first electric terminal and the second electric terminal.

10. The thermal fuse of claim 1, wherein the case has a maximum length and a minimum length in a side section taken along a protruding direction of the first electric terminal and the second electric terminal.

11. The thermal fuse of claim 1 further comprising:
flux being contacted with the fuse element.

12. The thermal fuse of claim 11, wherein the flux is colored, and the case has optical transparency.

13. The thermal fuse of claim 1, wherein the fusible alloy consists of Sn of not less than 43.5 wt % and not more than 50 wt %, In of not less than 0.1 wt % and not more than 5 wt %, Bi and inevitable impurities.

14. The thermal fuse of claim 1, wherein the fusible alloy consists of In of not less than 5 wt % and not more than 33 wt %, Zn of not less than 4.7 wt % and not more than 15.5 wt %, Sn and inevitable impurities.

15. A fusible alloy consisting of:
Sn of not less than 43.5 wt % and not more than 50 wt %;
In of not less than 0.1 wt % and not more than 5 wt %;
Bi; and
inevitable impurities,
wherein the fusible alloy has a fusing temperature of 128-138° C.

16. A fuse element comprising:
fusible alloy which is formed into any one of a plate, rod, and wire shape, the fusible alloy consisting of:
Sn of not less than 43.5 wt % and not more than 50 wt %;
In of not less than 0.1 wt % and not more than 5 wt %;
Bi; and
inevitable impurities,
wherein the fusible alloy has a fusing temperature of 128-138° C.

17. A fusible alloy consisting of:
In of not less than 5 wt % and not more than 33 wt %;
Zn of not less than 4.7 wt % and not more than 15.5 wt %;
Sn; and
inevitable impurities.

18. The fusible alloy of claim 17, wherein the In is not less than 9 wt % and not more than 15 wt %.

19. The fusible alloy of claim 17, wherein the Sn is not less than 51.5 wt % and not more than 90.3 wt %.

20. A fuse element comprising:
the fusible alloy as defined in claim 17, which is formed in any one of a plate, rod, and wire shape.

21. A fuse element comprising:
the fusible alloy as defined in claim 18, which is formed in any one of a plate, rod, and wire shape.

22. A fuse element comprising:
the fusible alloy as defined in claim 19, which is formed in any one of a plate, rod, and wire shape.

23. A thermal fuse comprising:
the fuse element as defined in claim 20;
two electric terminals connected to both ends of the fuse element; and
a cover for accommodating the fuse element.

24. A thermal fuse comprising:
the fuse element as defined in claim 21;
two electric terminals connected to both ends of the fuse element; and
a cover for accommodating the fuse element.

25. A thermal fuse comprising:
the fuse element as defined in claim 22;
two electric terminals connected to both ends of the fuse element; and
a cover for accommodating at least the fuse element.

26. The thermal fuse of claim 23, wherein the thermal fuse has a radial-type structure in which the two electric terminals protrude from an identical end in an identical direction.

27. The thermal fuse of claim 23, wherein the thermal fuse has a axial-type structure in which each of the two electric terminals protrudes from each end of the cover.

28. A thermal fuse comprising:
a substrate;
a pair of lead terminals disposed on the substrate;
a fuse element disposed across the pair of lead terminals; and
a cover for accommodating the fuse element,
wherein, the fuse element is the fuse element as defined in claim 20.

29. The thermal fuse of claim 28, wherein the cover has optical transparency, and colored flux is sealed in the cover.

30. A method of manufacturing a fusible alloy comprising the steps of:
weighing and mixing In of not less than 5 wt % and not more than 33 wt %, Zn of not less than 4.7 wt % and not more than 15.5 wt % and Sn of a remaining ratio;
fusing the mixed metals in a fusing furnace to obtain an alloy; and
cooling the fused alloy.

31. The thermal fuse according to claim 7, wherein the case has a substantially trapezoidal section taken along a protruding direction of the first electric terminal and the second electric terminal.

32. The thermal fuse according to claim 8, wherein the case has a substantially trapezoidal section taken along a protruding direction of the first electric terminal and the second electric terminal.
